(19) United States
(12) Patent Application Publication
(10) Pub. No.: US 2026/0175601 A1
(43) Pub. Date: Jun. 25, 2026

(54) PRINTER APPARATUS

(71) Applicant: TOSHIBA TEC KABUSHIKI KAISHA, Tokyo (JP)

(72) Inventors: Tsuyoshi Sanada, Susono Shizuoka (JP); Kenji Eoka, Sunto Shizuoka (JP); Yuji Kawamorita, Mishima Shizuoka (JP); Tsuyoshi Shimada, Mishima Shizuoka (JP)

(21) Appl. No.: 19/248,557

(22) Filed: Jun. 25, 2025

(30) Foreign Application Priority Data
Dec. 23, 2024 (JP) 2024-226541

(51) Int. Cl. B41J 15/04; B41J 3/407; B41J 29/13

(52) U.S. Cl. CPC B41J 15/042; B41J 3/407; B41J 29/13

(57) ABSTRACT

A printer includes: a box-shaped main body; a lid having one end portion pivotably coupled to the main body to open and close the opening; a storage portion to store roll paper, the storage portion being a space between an inner surface of the main body and an inner surface of the lid; a printing portion to perform printing while pulling out paper from the roll paper; a paper discharge port located between another end portion of the lid and an edge of the opening and configured to discharge the paper after printing; and a low friction sheet to reduce a frictional force, the low friction sheet being provided in a predetermined range including a position on an opposite side relative to a peeling point.

### CROSS-REFERENCE TO RELATED APPLICATION

This application is based upon and claims the benefit of priority from Japanese Patent Application No. 2024-226541, filed on December 23, 2024, the entire contents of which are incorporated herein by reference.

### FIELD

Embodiments described herein relate generally to a printer apparatus and thermal printer.

### BACKGROUND

In related art, a printer apparatus that stores roll paper, performs printing on paper pulled out from the roll paper, and discharges the paper is used. In such a printer apparatus, in order to smoothly convey the paper and improve printing accuracy, a roller that reduces a frictional force generated between the roll paper and a storage portion thereof may be provided.

As the size of the printer apparatus is reduced, it is difficult to provide the roller as described above in the storage portion of the roll paper, and an alternative solution is required. Further, there is a demand for cost reduction in changing to the alternative solution. Still further, in a case where the printer apparatus supports a configuration in which paper is discharged from a side surface of the apparatus and a configuration in which the paper is discharged from a top surface of the apparatus, it is required to reduce cost of installation of the alternative solution.

### DESCRIPTION OF THE DRAWINGS

FIG. 1 is a perspective view showing an example of appearance of a printer apparatus according to an embodiment.

FIG. 2 is a perspective view showing the printer apparatus in a state in which a housing is opened.

FIG. 3 is a cross-sectional view showing an example of an internal structure of the printer apparatus.

FIG. 4 shows a positional relationship between roll paper and a low friction sheet.

FIG. 5 shows a positional relationship between the roll paper and the low friction sheet.

FIG. 6 shows a positional relationship between the roll paper and the low friction sheet.

FIG. 7 shows a positional relationship between the roll paper and the low friction sheet.

### DETAILED DESCRIPTION

A problem to be solved by the disclosure is to provide a structure that enables a low cost solution for reducing a frictional force generated between roll paper and a storage portion in a printer apparatus that can adopt a configuration in which paper is discharged from a side surface of the apparatus and a configuration in which the paper is discharged from a top surface of the apparatus.

In general, according to one embodiment, a printer apparatus includes: a box-shaped main body having an opening at one surface; a lid having one end portion pivotably coupled to the main body by a hinge portion and configured to open and close the opening according to pivoting; a storage portion configured to store roll paper, the storage portion being a space between an inner surface of the main body and an inner surface of the lid; a printing portion configured to perform printing while pulling out paper from the roll paper; a paper discharge port located between another end portion of the lid and an edge of the opening and configured to discharge the paper after printing; and a low friction sheet configured to reduce a frictional force generated between an inner surface of the storage portion and an outer peripheral surface of the roll paper, the low friction sheet being provided in a predetermined range including a position on an opposite side relative to a peeling point where the paper pulled out from the roll paper is separated from the roll paper with the center of gravity of the roll paper stored in the storage portion interposed therebetween.

### First Embodiment

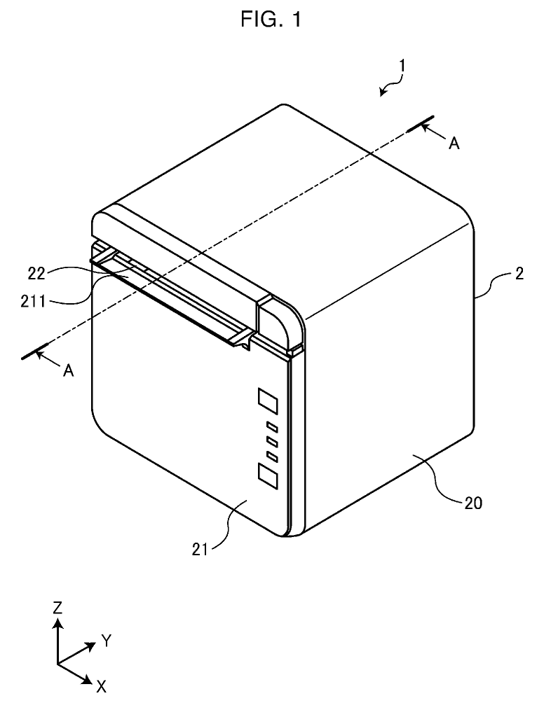

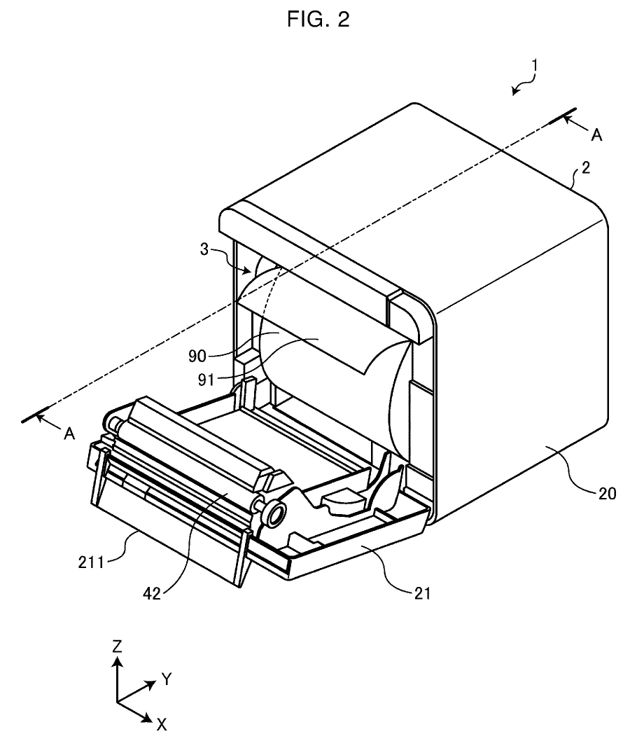

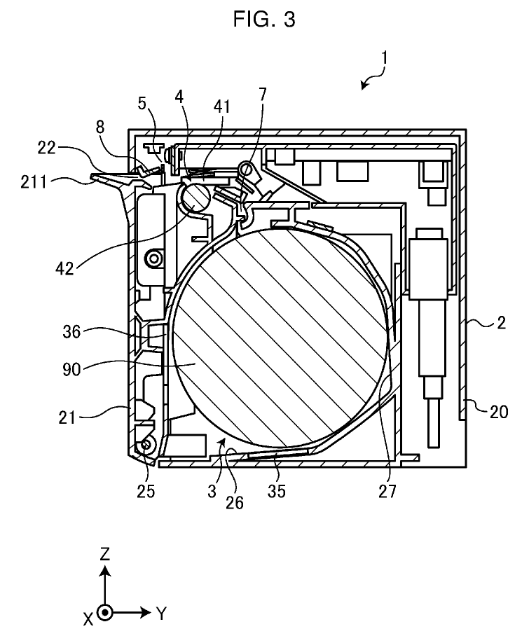

The embodiment will be described with reference to the drawings. FIG. 1 is a perspective view showing an example of appearance of a printer apparatus 1 according to the embodiment. FIG. 2 is a perspective view showing the printer apparatus 1 in a state in which a housing 2 is opened. FIG. 3 is a cross-sectional view showing an example of an internal structure of the printer apparatus 1, and is a cross-sectional view of the printer apparatus 1 taken along line A-A in FIG. 1.

The printer apparatus 1 includes the housing 2, a paper storage portion 3, a printing portion 4, a cutting portion 5, and a buffer portion 7. In the drawings, an X-axis direction indicates a width direction (left-right direction) of the printer apparatus 1, a Y-axis direction indicates a depth direction (front-rear direction) of the printer apparatus 1, and a Z-axis direction indicates a height direction (up-down direction) of the printer apparatus 1. A positive direction of the Z-axis is upward from the bottom of the printer apparatus 1. A positive direction of the Y-axis is a direction from a front side to a rear side of the printer apparatus 1. A positive direction of the X-axis is a direction from left to right when the printer apparatus 1 is viewed in the positive direction of the Y-axis.

The printer apparatus 1 according to the embodiment is a thermal printer and is used as a receipt printer for printing (printing, outputting, issuing) receipts, for example.

The housing 2 houses other portions (the paper storage portion 3, the printing portion 4, the cutting portion 5, the buffer portion 7, and the like). The housing 2 includes a box-shaped main body 20 having an opening on one surface (a front surface portion in FIGS. 1 and 2), and a lid 21 that opens and closes the opening. As shown in FIG. 3, one end portion of the lid 21 is pivotably coupled to an edge of the opening of the main body 20 by a hinge portion 25, and the lid 21 opens and closes the opening along with the pivoting.

In a state in which the lid 21 closes the main body 20, as shown in FIG. 1, a paper discharge port 22 is formed between the other end portion of the lid 21 and the edge of the opening of the main body 20. The paper discharge port 22 is an opening for discharging paper 91 from the housing 2.

The lid 21 of the printer apparatus 1 has a support portion 211 protruding to the outside of the paper discharge port 22. The support portion 211 is provided downstream of the cutting portion 5 in a paper conveying direction and has an inclined surface that comes into contact with a back surface of a printed surface of the paper 91 to support the paper 91. The support portion 211 is located outside the paper discharge port 22 and supports a lower side of the paper 91 discharged from the paper discharge port 22. The support portion 211 is detachably attached to the paper discharge port 22 or is provided integrally with the paper discharge port 22. That is, the support portion 211 is detachably attached at the lid 21 or integrally formed with the lid 21. The support portion 211 may be referred to as a table.

The printer apparatus 1 supports two configurations. One of the configurations is a configuration in which the paper discharge port 22 of the printer apparatus 1 discharges the paper 91 to the front (that is, in a negative direction of the Y-axis). Hereinafter, this configuration is referred to as "front paper discharge configuration". The printer apparatus 1 in FIGS. 1 to 3 adopts the front paper discharge configuration. The other configuration is a configuration in which the paper discharge port 22 discharges the paper 91 upward (that is, in the positive direction of the Z-axis). Hereinafter, this configuration is referred to as "top surface paper discharge configuration". The printer apparatus 1 that adopts the top surface paper discharge configuration is in a state in which the printer apparatus 1 is rotated by 90° in a clockwise direction in FIG. 3 around the width direction (X-axis direction).

The paper storage portion 3 is a space between a recessed inner surface of the main body 20 and an inner surface of the lid 21, and stores the roll paper 90 such that the paper 91 can be pulled out from the roll paper 90. The roll paper 90 is wounded the strip-shaped paper 91 with the first surface facing outward. The first surface in the embodiment is a surface where printing is performed (that is, the printed surface). Therefore, an outer peripheral surface of the roll paper 90 is the printed surface of the paper 91. The back surface of the printed surface is an example of the second surface. The paper 91 is an example of a sheet-shaped printing medium. In a state in which the lid 21 is located at a position where the main body 20 is opened, the paper storage portion 3 is opened and the roll paper 90 can be replaced or added.

The printer apparatus 1 performs printing on the paper 91 while pulling out and conveying the paper 91 from the roll paper 90 stored in the paper storage portion 3.

The buffer portion 7 functions as a so-called damper using elasticity of a member forming a bent paper conveying path, and absorbs tension applied to the paper 91 until the roll paper 90 starts to rotate stably as the paper 91 starts to be conveyed. Accordingly, the buffer portion 7 stabilizes printing of the printing portion 4.

The printing portion 4 performs printing on the paper 91 while pulling out and conveying the paper 91 from the roll paper 90 wounded the strip-shaped paper 91, and includes a print head 41 and a platen 42. The print head 41 is provided at the main body 20, and the platen 42 is provided at the lid 21. The platen 42 in the embodiment is a roller and is rotationally driven to convey the paper 91 interposed between the platen 42 and the print head 41.

The print head 41 is a thermal head having a structure in which a plurality of heat-generating elements are aligned. The print head 41 performs printing on the paper 91 interposed between the platen 42 and the print head 41 by causing a heat-generating element corresponding to a printing pattern to generate heat.

More specifically, the print head 41 is attached to the support portion and is disposed at a position facing the platen 42. The support portion is biased by an elastic force of a spring in a direction in which the print head 41 is pressed into contact with the platen 42. Accordingly, the print head 41 is biased in a direction in which the print head 41 is pressed against the platen 42.

When replenishing or replacing the roll paper 90, a user opens the lid 21, replenishes or replaces the roll paper 90, interposes a leading end portion of the paper 91 pulled out from the roll paper 90 between the platen 42 and the print head 41, and closes the lid 21. Accordingly, the leading end portion of the paper 91 is held by the platen 42 and the print head 41.

The cutting portion 5 is provided downstream of the printing portion 4 in the paper conveying direction, cuts the paper 91, and includes a fixed blade and a movable blade. The movable blade is a blade movable in a thickness direction of the paper 91. A moving mechanism for moving the movable blade moves the movable blade in the up-down direction (Z-axis direction) in the drawing under the control of a control unit mounted on the printer apparatus 1. The fixed blade is provided at a position facing the movable blade at a fixed position in the main body 20.

When printing on the paper 91 is completed, the movable blade moves from a back side of the paper 91 to a front side of the paper 91, and the paper 91 is interposed between the moved movable blade and the fixed blade, whereby the paper 91 is cut. The front side of the paper 91 corresponds to, for example, the printed surface of the paper 91. The back side of the paper 91 corresponds to a side opposite to the printed surface (non-printed surface) of the paper 91.

Use of the cutting portion 5 is not limited to cutting (full cutting) the paper 91. For example, the cutting portion 5 can also execute partial cutting for cutting a part of the paper 91. The full cutting and the partial cutting are set in advance via an operation portion (not shown) according to an instruction of the user.

### Supplement to Shape of Paper Storage Portion

In the case of the front paper discharge configuration shown in FIGS. 1 to 3, the paper storage portion 3 is offset toward the hinge portion 25 (see FIG. 3) that pivotably couples the main body 20 and the lid 21, and has an inner surface shape for storing the roll paper 90. Specifically, for example, an inner surface 26 located below the roll paper 90 in the case of the front paper discharge configuration is inclined downward toward the hinge portion 25.

In the case of the top surface paper discharge configuration, since the lid 21 is a top surface, the roll paper 90 is located at the bottom of the main body 20 away from the lid 21. The bottom of the main body 20 is offset toward a side closer to the hinge portion 25 rather than the printing portion 4, and has an inner surface shape for positioning the roll paper 90. Specifically, for example, an inner surface 27 located below the roll paper 90 in the case of the top surface paper discharge configuration is inclined downward toward the hinge portion 25.

### Low Friction Sheet

As shown in FIG. 3, the paper storage portion 3 includes low friction sheets 35 and 36. The low friction sheets 35 and 36 are provided in a predetermined range of the inner surface of the paper storage portion 3, face the outer peripheral surface of the roll paper 90, and reduce a frictional force generated between the inner surface of the paper storage portion 3 and the outer peripheral surface of the roll paper 90.

More specifically, the low friction sheets 35 and 36 are located in a predetermined range including a position on an opposite side relative to a peeling point 95 where the paper 91 pulled out from the roll paper 90 is separated from the roll paper 90 with the center of gravity of the roll paper 90 stored in the paper storage portion 3 interposed therebetween.

The predetermined range includes a position closest to the outer peripheral surface of the roll paper 90 having a maximum diameter. Further, more preferably, the predetermined range also includes a position closest to the outer peripheral surface of the roll paper 90 having a diameter half the maximum diameter.

The low friction sheets 35 and 36 have a coefficient of friction with the outer peripheral surface of the roll paper 90 lower than that of the inner surface of the paper storage portion 3, and are, for example, sheets formed of (or including) ultra-high molecular weight polyethylene (UHMW-PE), nylon, or fluororesin such as polytetrafluoroethylene (PTFE).

When the low friction sheets 35 and 36 are made of nylon, a coefficient of dynamic friction with the outer peripheral surface of the roll paper 90 is, for example, 0.35. When the low friction sheets 35 and 36 are made of ultra-high molecular weight polyethylene (UHMW-PE), the coefficient of dynamic friction with the outer peripheral surface of the roll paper 90 is, for example, 0.15 to 0.24. When the low friction sheets 35 and 36 are made of fluororesin (PTFE), the coefficient of dynamic friction with the outer peripheral surface of the roll paper 90 is, for example, 0.06.

In contrast, since a coefficient of dynamic friction between the outer peripheral surface of the roll paper 90 and the inner surface of the paper storage portion 3 is, for example, 0.48, the coefficient of friction is reduced by providing the low friction sheets 35 and 36, and an effect of reducing the frictional force is expected.

The low friction sheet may be functionally provided on the entire inner surface of the paper storage portion 3, and is preferably partially provided from the viewpoint of cost reduction. The low friction sheet 35 is provided at the main body 20 side, and the low friction sheet 36 is provided at the lid 21. The low friction sheets 35 and 36 correspond to the two configurations (front paper discharge configuration and top surface paper discharge configuration) of the printer apparatus 1 described above.

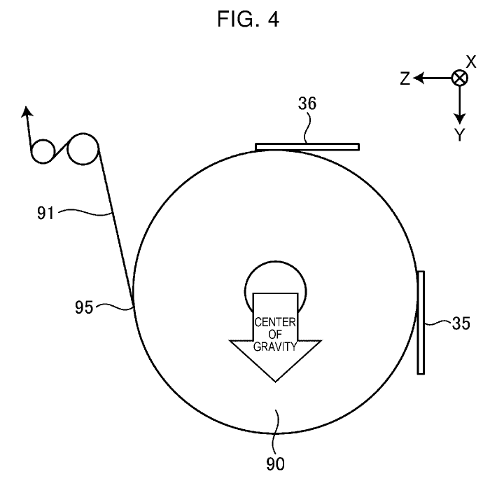

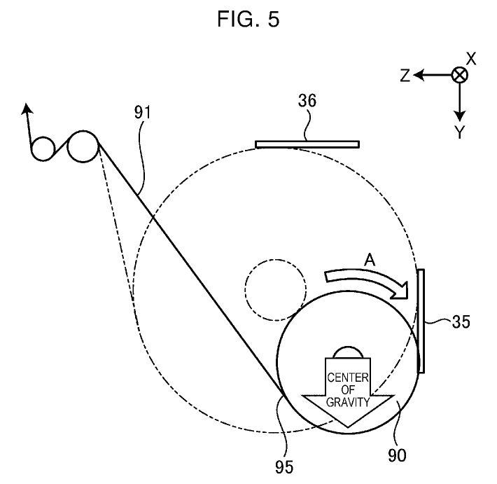

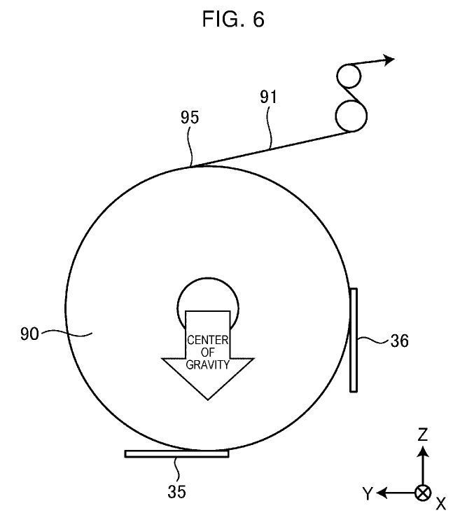

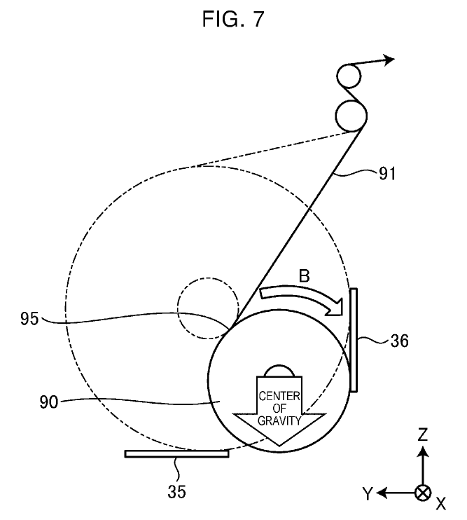

FIGS. 4 to 7 show positional relationships between the roll paper 90 and the low friction sheets 35 and 36. FIGS. 4 and 5 show states of the top surface paper discharge configuration, and FIGS. 6 and 7 show states of the front paper discharge configuration. In addition, the roll paper 90 in FIGS. 4 and 6 is in an unused state, and the roll paper 90 in FIGS. 5 and 7 is in a state in which the diameter is halved.

### Top Surface Paper Discharge Configuration

As shown in FIG. 4, when the roll paper 90 is in the unused state in the state of the top surface paper discharge configuration, a pull-out direction of the paper 91 is substantially upward, and is substantially opposite to a downward load of the roll paper 90. When a point where the pulled-out paper 91 is separated from the roll paper 90 is referred to as the peeling point 95, the outer peripheral surface of the roll paper 90 and the inner surface of the paper storage portion 3 come into contact with each other on the opposite side of the peeling point 95 with the center of gravity of the roll paper 90 interposed therebetween. Then, the outer peripheral surface of the roll paper 90 rotates downward on a contact surface with the inner surface of the paper storage portion 3 and slides on the contact surface. Since a frictional force generated accordingly is opposite to the load of the roll paper 90, the frictional force acts in a direction in which the roll paper 90 is lifted.

Therefore, a force with which the roll paper 90 presses the inner surface of the paper storage portion 3 is weakened by pulling out the paper 91 below the roll paper 90. Thus, an influence of the frictional force generated between the lower outer peripheral surface of the roll paper 90 and the inner surface of the paper storage portion 3 when the paper 91 is pulled out is not large (is weak).

Meanwhile, the outer peripheral surface of the roll paper 90 is strongly pressed against the inner surface of the paper storage portion 3 that is located at a position ahead of where the roll paper 90 rolls as the paper 91 is pulled out and serves to restrain the roll paper 90. Therefore, a frictional force generated at this position (referred to as the first press-contact position) is strong. Here, an arrow A in FIG. 5 indicates a rolling direction of the roll paper 90.

Therefore, the low friction sheet 35 for reducing the frictional force generated at the first press-contact position is provided at the position. The low friction sheet 35 is preferably located on the opposite side of the peeling point 95 with the center of gravity of the roll paper 90 interposed therebetween.

The peeling point 95, the center of gravity of the roll paper 90, and the low friction sheet 35 are not necessarily located side by side in a straight line, and it is sufficient if the center of gravity of the roll paper 90 is located at a position substantially between the peeling point 95 and the low friction sheet 35.

Here, as shown in FIG. 5, it is preferable that the low friction sheet 35 supports rotation of the roll paper 90 until the diameter of the roll paper 90 is approximately halved. In other words, it is preferable that the low friction sheet 35 is provided over a range including a range from a position where the outer peripheral surface of the roll paper 90 having the maximum diameter comes into contact to a position where the outer peripheral surface of the roll paper 90 having a diameter of about half the maximum diameter comes into contact on the inner surface of the paper storage portion 3.

When the diameter of the roll paper 90 is smaller than half, the load of the roll paper 90 is small, and accordingly the influence of the frictional force on printing accuracy is small. Thus, in this case, the low friction sheet 35 is unnecessary.

The low friction sheet 35 is provided at a plurality of locations in depth directions in FIGS. 4 and 5 (for example, both end portions in a width direction of the roll paper 90). The low friction sheet 35 is provided at least at three locations arranged in a paper width direction in a case where the printer apparatus 1 supports a plurality of paper widths and printing position alignment is based on one end portion of the paper 91 in the width direction.

### Front Paper Discharge Configuration

As shown in FIG. 6, when the roll paper 90 is in the unused state in the state of the front paper discharge configuration, the peeling point 95 is located above the roll paper 90, and the pull-out direction of the paper 91 is directed substantially in a lateral direction. Accordingly, the roll paper 90 easily rolls in the lateral direction, and is strongly pressed against the inner surface of the paper storage portion 3 at a position where the rolling is restrained (this is referred to as the second press-contact position). Here, an arrow B in FIG. 7 indicates the rolling direction of the roll paper 90.

Therefore, the low friction sheet 36 for reducing the frictional force generated at the second press-contact position is provided at the position. The low friction sheet 36 reduces the frictional force generated between the second press-contact position and the outer peripheral surface of the roll paper 90.

Similarly to the low friction sheet 35, the low friction sheet 36 is provided at a position on an opposite side of the peeling point 95 with the center of gravity of the roll paper 90 interposed therebetween. Similarly to the low friction sheet 35, for the low friction sheet 36, the peeling point 95, the center of gravity of the roll paper 90, and the low friction sheet 36 are not necessarily located side by side in a straight line, and it is sufficient if the center of gravity of the roll paper 90 is located at a position substantially between the peeling point 95 and the low friction sheet 36. As shown in FIG. 7, the peeling point 95 moves downward from directly above the roll paper 90 as the diameter of the roll paper 90 decreases.

At the second press-contact position, similarly to the first press-contact position, the outer peripheral surface of the roll paper 90 moving downward slides on the inner surface of the paper storage portion 3. Since a frictional force generated accordingly is opposite to the load of the roll paper 90, the frictional force acts in a direction in which the roll paper 90 is lifted.

Therefore, a force with which the roll paper 90 presses the inner surface of the paper storage portion 3 is weakened by pulling out the paper 91 below the roll paper 90. Thus, an influence of the frictional force generated between the lower outer peripheral surface of the roll paper 90 and the inner surface of the paper storage portion 3 when the paper 91 is pulled out is not large (is weak).

As shown in FIG. 7, the low friction sheet 36 supports the rotation of the roll paper 90 until the diameter of the roll paper 90 is approximately halved. In other words, the low friction sheet 36 is provided over a range including a range from a position where the outer peripheral surface of the roll paper 90 having the maximum diameter comes into contact to a position where the outer peripheral surface of the roll paper 90 having a diameter of about half the maximum diameter comes into contact on the inner surface of the paper storage portion 3.

When the diameter of the roll paper 90 is smaller than half, the load of the roll paper 90 is small, and thus the influence of the frictional force on the printing accuracy is sufficiently small. Thus, in this case, the low friction sheet 36 is unnecessary at a position where the outer peripheral surface of the roll paper 90 comes into contact.

More specifically, in a state in which the diameter of the roll paper 90 is large, the pull-out direction of the paper 91 is a direction in which the roll paper 90 is pressed against the low friction sheet 36, and as the diameter of the roll paper 90 decreases, the paper 91 and the low friction sheet 36 become close to parallel. Then, a force with which the roll paper 90 is pressed against the low friction sheet 36 is weakened. Then, it is not necessary to reduce the frictional force by the low friction sheet 36.

The low friction sheet 36 is provided at a plurality of locations in depth directions in FIGS. 6 and 7 (for example, two or more locations such as both end portions in the width direction of the roll paper 90). Further, the low friction sheet 36 is provided at least at three locations in the paper width direction in a case where the printer apparatus 1 supports a plurality of paper widths and printing position alignment is based on one end portion of the paper 91 in the width direction. The three locations are a position in contact with a side (one end portion) serving as a reference for the printing position alignment, a position in contact with the other end portion of the roll paper 90 having a small width, and a position in contact with the other end portion of the roll paper 90 having a large width among side end portions in the width direction of the outer peripheral surface of the roll paper 90.

In the printer apparatus 1 having such a configuration, when printing by the printing portion 4 is started and the paper 91 is conveyed, the roll paper 90 rotates. When the roll paper 90 rotates, the roll paper 90 rolls to the opposite side of the peeling point 95 with the center of gravity interposed therebetween and is pressed into contact with the inner surface of the paper storage portion 3. The press-contact position is the first press-contact position in the top surface paper discharge configuration shown in FIGS. 4 and 5, and is the second press-contact position in the front paper discharge configuration shown in FIGS. 6 and 7.

The low friction sheet 35 is provided at the first press-contact position that is the press-contact position in the top surface paper discharge configuration. The low friction sheet 36 is provided at the second press-contact position that is the press-contact position in the front paper discharge configuration.

Accordingly, support for reducing the frictional force by the low friction sheet (the low friction sheet 35 or the low friction sheet 36) is obtained regardless of paper discharge directions, rotatability of the roll paper 90 is improved, thus conveyance of the paper 91 is not hindered, and thus it is possible to obtain favorable printing accuracy.

The above-described embodiment can be appropriately modified and implemented by changing a part of configurations or functions of each apparatus described above. Therefore, modifications according to the above-described embodiment will be described below. Hereinafter, differences from the above-described embodiment will be mainly described, the same reference signs will be used for the same points as contents already described, and detailed description thereof will be omitted. In addition, modifications described below may be individually implemented or may be implemented in combination as appropriate.

### First Modification

In the case of the front paper discharge configuration (see FIG. 7), the paper 91 is pulled out in the direction in which the roll paper 90 is pressed against the low friction sheet 36. On the other hand, in the case of the top surface paper discharge configuration (see FIG. 5), the paper 91 is pulled out in the direction away from the low friction sheet 35.

From this, it is considered that a pressing force applied to the low friction sheet 35 is smaller than a pressing force applied to the low friction sheet 36 at least in a state in which the diameter of the roll paper 90 is somewhat reduced.

Therefore, an installation range of the low friction sheet 35 may be smaller than an installation range of the low friction sheet 36. In other words, a range where friction is reduced by the low friction sheet 35 may be a predetermined range including the position where the outer peripheral surface of the roll paper 90 having the maximum diameter comes into contact, and the predetermined range may not include the position where the outer peripheral surface of the roll paper 90 having a diameter of about half the maximum diameter comes into contact.

With such a configuration, since the size of the low friction sheet 35 can be reduced, the same effect as that of the above-described embodiment can be obtained at lower cost.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer apparatus, comprising:
a box-shaped main body having an opening at one surface;
a lid having one end portion pivotably coupled to the main body by a hinge portion and configured to open and close the opening according to pivoting;
a storage component configured to store roll paper, the storage component being a space between an inner surface of the main body and an inner surface of the lid;
a printing component configured to perform printing while pulling out paper from the roll paper;
a paper discharge port located between another end portion of the lid and an edge of the opening and configured to discharge the paper after printing; and
a low friction sheet configured to reduce a frictional force generated between an inner surface of the storage component and an outer peripheral surface of the roll paper, the low friction sheet being provided in a predetermined range including a position on an opposite side relative to a peeling point where the paper pulled out from the roll paper is separated from the roll paper with a center of gravity of the roll paper stored in the storage component interposed therebetween.

2. The printer apparatus according to claim 1, wherein
the low friction sheet is provided at the inner surface of the lid and the inner surface of the main body.

3. The printer apparatus according to claim 1, wherein
the low friction sheet is provided in the predetermined range including a position closest to the outer peripheral surface of the roll paper having a maximum diameter.

4. The printer apparatus according to claim 1, wherein
the low friction sheet provided at the inner surface of the lid is provided in the predetermined range including a range from a position closest to the outer peripheral surface of the roll paper having a maximum diameter and a position closest to the outer peripheral surface of the roll paper having a diameter half the maximum diameter.

5. The printer apparatus according to claim 1, wherein
the low friction sheet is provided at a plurality of locations arranged along a width direction of the roll paper.

6. The printer apparatus according to claim 1, wherein
the low friction sheet has a first coefficient of friction with the outer peripheral surface of the roll paper lower than a second coefficient of friction with the inner surface of the paper storage component.

7. The printer apparatus according to claim 1, wherein
the low friction sheet comprises one or more of ultra-high molecular weight polyethylene, nylon, and a fluororesin.

8. The printer apparatus according to claim 1, wherein
the low friction sheet has a coefficient of dynamic friction with the outer peripheral surface of the roll paper of about 0.35 or less.

9. The printer apparatus according to claim 1, wherein
the low friction sheet has a coefficient of dynamic friction with the outer peripheral surface of the roll paper of about 0.24 or less.

10. The printer apparatus according to claim 1, wherein
the low friction sheet has a coefficient of dynamic friction with the outer peripheral surface of the roll paper of about 0.06 or less.

11. A thermal printer, comprising:
a box-shaped main body having an opening at one surface;
a lid having one end portion pivotably coupled to the main body by a hinge portion and configured to open and close the opening according to pivoting;
a storage component configured to store roll paper, the storage component being a space between an inner surface of the main body and an inner surface of the lid;
a thermal printing component comprising a thermal print head configured to perform thermal printing while pulling out paper from the roll paper;
a paper discharge port located between another end portion of the lid and an edge of the opening and configured to discharge the paper after thermal printing; and
a low friction sheet configured to reduce a frictional force generated between an inner surface of the storage component and an outer peripheral surface of the roll paper, the low friction sheet being provided in a predetermined range including a position on an opposite side relative to a peeling point where the paper pulled out from the roll paper is separated from the roll paper with a center of gravity of the roll paper stored in the storage component interposed therebetween.

12. The thermal printer according to claim 11, wherein
the low friction sheet is provided at the inner surface of the lid and the inner surface of the main body.

13. The thermal printer according to claim 11, wherein
the low friction sheet is provided in the predetermined range including a position closest to the outer peripheral surface of the roll paper having a maximum diameter.

14. The thermal printer according to claim 11, wherein
the low friction sheet provided at the inner surface of the lid is provided in the predetermined range including a range from a position closest to the outer peripheral surface of the roll paper having a maximum diameter and a position closest to the outer peripheral surface of the roll paper having a diameter half the maximum diameter.

15. The thermal printer according to claim 11, wherein
the low friction sheet is provided at a plurality of locations arranged along a width direction of the roll paper.

16. The thermal printer according to claim 11, wherein
the low friction sheet has a first coefficient of friction with the outer peripheral surface of the roll paper lower than a second coefficient of friction with the inner surface of the paper storage component.

17. The thermal printer according to claim 11, wherein
the low friction sheet comprises one or more of ultra-high molecular weight polyethylene, nylon, and a fluororesin.

18. The thermal printer apparatus according to claim 1, wherein
the low friction sheet has a coefficient of dynamic friction with the outer peripheral surface of the roll paper of about 0.35 or less.

19. The thermal printer according to claim 11, wherein
the low friction sheet has a coefficient of dynamic friction with the outer peripheral surface of the roll paper of about 0.24 or less.

20. The thermal printer according to claim 11, wherein
the low friction sheet has a coefficient of dynamic friction with the outer peripheral surface of the roll paper of about 0.06 or less.
